(19) United States
(12) Patent Application Publication
(10) Pub. No.: US 2004/0126182 A1
(43) Pub. Date: Jul. 1, 2004

(54) Connector

(76) Inventor: Yu-Cheng Lin, Taichung (TW)

Correspondence Address: Mr. Charles E. Baxley, CHARLES E. BAXLEY, 59 John Street, New York, NY, 10038, US

(21) Appl. No.: 10/331,445

(22) Filed: Dec. 27, 2002

(51) Int. Cl. B25G 3/18

(52) U.S. Cl. 403/322.2

(57) ABSTRACT

A connector includes an extension shank, a sleeve, a control bar, a spring, a fastener and a ball detent. The extension shank defines an axial cavity and first and second holes communicated with the axial cavity. The sleeve defines a tunnel and a hole communicated with the tunnel. The control bar defines a hole, a deep recess and a shallow recess located near the deep recess. The spring is put in the axial cavity before the control bar is inserted in the axial cavity. The fastener is inserted in the hole defined in the sleeve, the first hole defined in the extension shank and the hole defined in the control bar for combining the sleeve with the control bar. The diameter of the first hole defined in the extension shank is greater than that of the fastener for allowing the sleeve and the control bar to move relative to the extension shank. The ball detent is trapped in the second hole defined in the extension shank. The spring keeps the control bar in a position where the ball detent includes a portion received in the shallow recess and a second portion extending from the second hole defined in the extension shank. The sleeve and the control bar can be moved to a second position where the first portion of the ball detent is received in the deep recess and the second portion of the ball detent is hidden in the second hole defined in the extension shank.

### BACKGROUND OF THE INVENTION

1. Field of Invention

The present invention relates to a tool including a handle and a tool bit for releasable engagement with the handle and, more particularly, to a connector for connecting the handle with the tool bit.

2. Related Prior Art

Taiwan Patent Publication No. 262789 discloses a conventional connector including a rod 10, a ball detent 15, a control bar 20, a spring 24 and a button 30. The rod 10 defines an axial cavity 13, a hole 14 communicated with the axial cavity 13 and a hole 11 communicated with the axial cavity 13. The control bar 20 includes a slot 21 longitudinally extending therein. The slot 21 including a long opening in a first side and a short opening in a second side opposite to the first side. In addition, a deep recess 22 and a shallow recess 22 are defined in the second side of the rod 20. The button 30 includes a hook 31 formed at an end and an inclined edge 32 formed next to the hook 31. The ball detent 15 is put in the hole 14. The wall of the hole 14 is processed so as to trap the ball detent 15 in the hole 14. The spring 24 is received in the axial cavity 13. The control bar 20 is inserted into the axial cavity 13. The control bar 20 is biased by means of the spring 24. The button 30 is partially inserted into the hole 11. The hook 31 is received in the long opening of the slot 21 and the inclined edge 32 is received in the short opening of the slot 21. Normally, the ball detent 15 is partially received in the shallow recess 23 and partially inserted from the hole 14 for locking a tool bit. The button 30 can be pushed in order to move the control bar 20 further into the axial cavity 13. Thus, the ball detent 15 is partially received in the deep recess 22 and hidden in the hole 14.

Taiwanese Patent Publication No. 349462 discloses a conventional connector including a rod 10, a ball detent R, a control bar 30, a spring 20 and a switch 50. The rod 10 defines an axial cavity 13, a hole 14 communicated with the axial cavity 13 and a slot 16 communicated with the axial cavity 13. The control bar 30 defines a deep recess 31, a shallow recess 32 communicated with the deep recess 31 and a recess 33 separated from the shallow recess 32. The switch 50 includes a boss 52. The ball detent R is put in the hole 14. The wall of the hole 14 is processed so as to trap the ball detent R in the hole 14. The spring 20 is received in the axial cavity 13. The control bar 30 is inserted into the axial cavity 13. The control bar 30 is biased by means of the spring 20. The switch 50 is partially inserted into the slot 16. The boss 52 is received in the recess 33. Normally, the ball detent R is partially received in the shallow recess 32 and partially inserted from the hole 14 for locking a tool bit. The switch 50 can be moved so as to move the control bar 30 further into the axial cavity 13. Thus, the ball detent R is partially received in the deep recess 31 and hidden in the hole 14.

Taiwanese Patent Publication No. 349463 discloses a conventional connector including a rod 10, a ball detent R, a control bar 30, a spring 20 and a switch assembly including a slide 50 and a collar 60. The rod 10 defines an axial cavity 13, a hole 14 communicated with the axial cavity 13 and a slot 16 communicated with the axial cavity 13. The control bar 30 defines a deep recess 31, a shallow recess 32 communicated with the deep recess 31 and a recess 33 separated from the shallow recess 32. The slide 50 includes a boss 51 formed on a side, a recess 52 defined in an opposite side, a spring 53 received in the recess 52 and a key 54 received in the recess 52. The ball detent R is put in the hole 14. The wall of the hole 14 is processed so as to trap the ball detent R in the hole 14. The spring 20 is received in the axial cavity 13. The control bar 30 is inserted into the axial cavity 13. The control bar 30 is biased by means of the spring 20. The slide 50 is partially inserted into the slot 16. The boss 51 is received in the recess 33. The collar 60 is mounted on the rod 10. The key 54 is received in a recess defined in an internal side of the collar 60 so that the slide 50 and the collar 60 are assembled. Normally, the ball detent R is partially received in the shallow recess 32 and partially inserted from the hole 14 for locking a tool bit. The switch 50 can be moved so as to move the control bar 30 further into the axial cavity 13. Thus, the ball detent R is partially received in the deep recess 31 and hidden in the hole 14.

Taiwanese Patent Publication No. 450183 discloses a telescopic connector including a tube 20, a rod 30, a ball detent 50, a collar 60, a spring 70 and a C-ring 71. The tube 20 defines a hole 21 communicated with an axial cavity 23. The rod 30 defines a plurality of recesses 32. An inclined face 61 and a shoulder 62 are formed on an internal side of the collar 60. The ball detent 50 is put in the hole 21. The wall of the hole 21 is processed so as to trap the ball detent 50 in the hole 21. The rod 30 is inserted in the tube 20. The ball detent 50 is partially received in one of the recesses 32. The collar 60 is mounted on the tube 20. The spring 70 is mounted on the tube 20. The C-ring 71 is received in an annular groove defined in an external side of the tube 20. Thus, the spring 70 is compressed between the shoulder of the collar 60 and the C-ring 71. Because of the inclined face 61 of the collar 60 biased via the spring 70, the ball detent 50 is partially inserted into one of the recesses 32 for retaining the tube 20 in a position relative to the rod 30. The collar 60 can be moved so as to disengage the inclined face 61 from the ball detent 50, thus allowing the ball detent 50 to completely escape any of the recesses 32.

Taiwanese Patent Publication No. 466995 discloses a telescopic connector including a handle 10, a rod 30, a ball detent 40, a collar 20, a spring 50 and a C-ring 60. The handle 10 defines an axial cavity 11 and a hole 12 communicated with the axial cavity 11. An annular groove 13 is defined in an external side of the handle 10. The rod 30 defines a plurality of recesses 32. An inclined face 21 and a shoulder are formed on an internal side of the collar 20. The ball detent 40 is put in the hole 12. The wall of the hole 12 is processed so as to trap the ball detent 40 in the hole 12. The rod 30 is inserted in the handle 10. The ball detent 40 is partially received in one of the recesses 32. The collar 20 is mounted on the handle 10. The spring 50 is mounted on the handle 10. The C-ring 60 is received in the annular groove 13. Thus, the spring 50 is compressed between the shoulder of the collar 20 and the C-ring 60. Because of the inclined face 21 of the collar 20 biased via the spring 50, the ball detent 40 is partially inserted into one of the recesses 32 for retaining the handle 10 in a position relative to the rod 30. The collar 20 can be moved so as to disengage the inclined face 21 from the ball detent 40, thus allowing the ball detent 40 to completely escape any of the recesses 32.

Taiwanese Patent Publication No. 258060 discloses a connector including a rod 1, collar 10, a ring 18, a fastener 19, a control bar 21, a ball detent 26 and a spring 24. The rod I defines an axial cavity 3, a hole 2 communicated with the axial cavity 3 and a hole 6 communicated with the axial cavity 3. An annular groove 4 is defined in an external side of the rod 1. The collar 2 defines an axial cavity 13 and a hole 12 communicated with the axial cavity 13. A shoulder 14 is formed on an internal side of the collar 10. The control bar 21 defines a hole 22 and a recess 23. The collar 10 and the spring 24 are mounted on the rod 1. The ring 18 is received in the annular groove 4. The ball detent 26 is put in the hole 6. The control bar 21 is inserted in the axial cavity 3. The fastener 19 is inserted in the hole 12 of the collar 10, the hole 2 of the rod 1 and the hole 22 of the control bar 21. The width of the hole 2 is greater than the width of the fastener 19 so that the fastener 19 is movable in the hole 2. The spring 24 is compressed between the shoulder 14 and the ring 18. Since being connected with the collar 10 through the fastener 19, the control bar 21 is biased via the spring 24. Thus, the control bar 21 pushes the ball detent 26 so that the ball detent 26 partially extends from the hole 6 for locking tool bit. As the collar 10 is moved on the rod 1, the control bar 21 is moved relative to the rod 1. When the recess 23 is aligned with the hole 6 so as to receive a portion of the ball detent 26, thus concealing the remaining portion of the ball detent 26 in the hole 6.

U.S. Pat. No. 4938107 discloses a wedge locking socket device with an extension shank 9 and a socket 21. The extension shank 9 includes a driving portion 12. The socket 21 defines a recess for receiving the driving portion 12. The driving portion 12 includes a shoulder 58 formed thereon, a slot 10 defined therein and a hole 19 communicated with the slot 10. A limiting collar 52 is mounted on the driving portion 12 with an end located against the shoulder 58. A spring 17 is mounted on the driving portion 12. A sleeve 15 is mounted on the driving portion 12. The sleeve 15 includes two rings 28 and 29 formed on an internal side. The spring 17 is compressed between the limiting collar 52 and the ring 28. Two ball detents 22 and 24 are put in the hole 19. A control bar 14 is put in the slot 10. The control bar 14 includes a spur 16 and an inclined edge 22. The spur 16 is held between the rings 28 and 29. The spring 17 pushes the sleeve 15 and therefore the control bar 14 towards the ball detents 22. Because of engagement of the inclined edges 25 with the ball detent 22, the control bar 14 and the ball detent 24 are moved outwardly so as to abut against two opposite walls 31 of the recess defined in the socket 21. The sleeve 15 and therefore the control bar 14 can be moved from the ball detent 22 in order to disengage the control bar 14 and the ball detent 24 from the walls 31.

### SUMMARY OF THE INVENTION

It is the primary objective of the present invention to provide a structurally simple connector for connecting a tool with a tool bit.

According to the present invention, a connector includes an extension shank, a sleeve, a control bar, a spring, a fastener and a ball detent. The extension shank defines an axial cavity and first and second holes communicated with the axial cavity. The sleeve defines a tunnel and a hole communicated with the tunnel. The control bar defines a hole, a deep recess and a shallow recess located near the deep recess. The spring is put in the axial cavity before the control bar is inserted in the axial cavity. The fastener is inserted in the hole defined in the sleeve, the first hole defined in the extension shank and the hole defined in the control bar for combining the sleeve with the control bar. The diameter of the first hole defined in the extension shank is greater than that of the fastener for allowing the sleeve and the control bar to move relative to the extension shank. The ball detent is trapped in the second hole defined in the extension shank. The spring keeps the control bar in a position where the ball detent includes a portion received in the shallow recess and a second portion extending from the second hole defined in the extension shank. The sleeve and the control bar can be moved to a second position where the first portion of the ball detent is received in the deep recess and the second portion of the ball detent is hidden in the second hole defined in the extension shank.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of a connector according to a first embodiment of the present invention.

FIG. 2 is an exploded view of the connector shown in FIG. 1.

FIGS. 3-5 are cross-sectional views of the connector shown in FIG. 1.

FIG. 6 is a perspective view of a connector according to a second embodiment of the present invention.

FIG. 7 is a perspective view of a connector according to a third embodiment of the present invention.

### DETAILED DESCRIPTION OF EMBODIMENTS

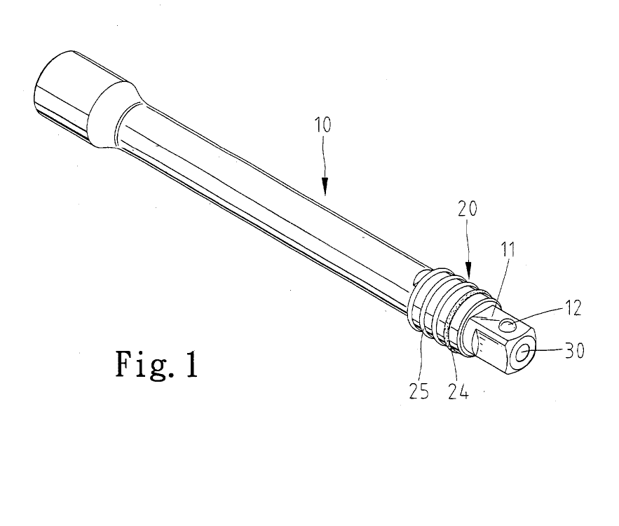

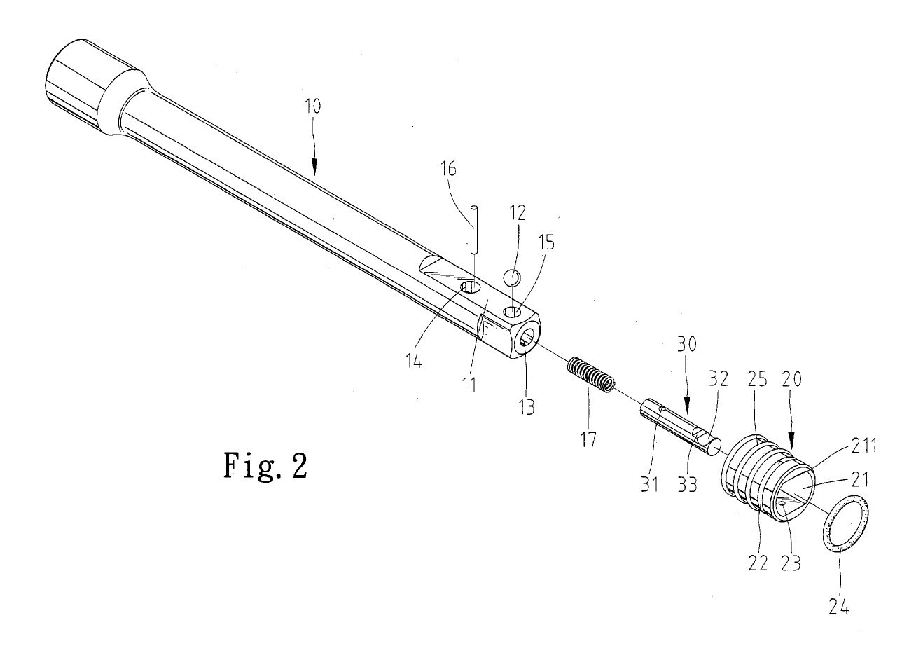

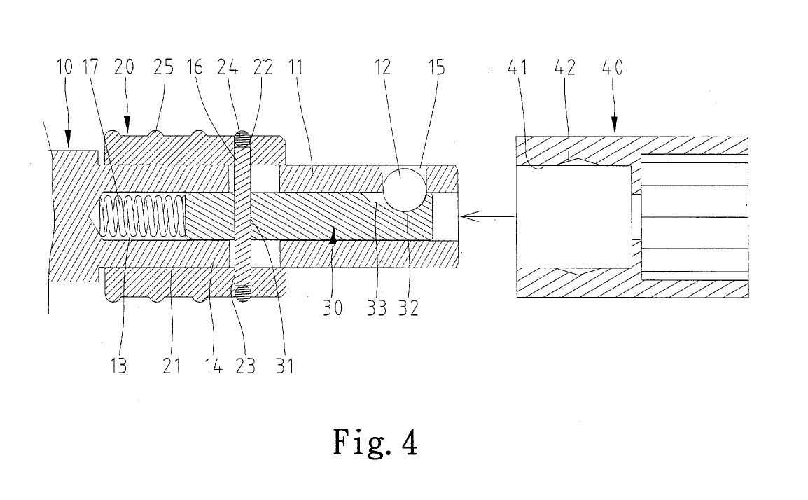

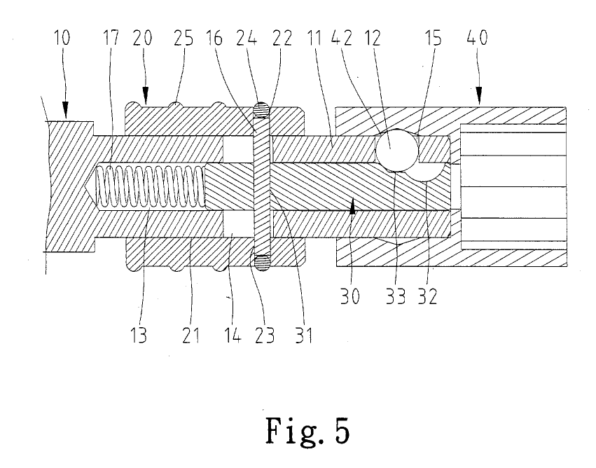

Referring to FIGS. 1 and 2, according to a first embodiment of the present invention, a connector for connecting a tool (not shown) with a tool bit 40 (shown in FIGS. 4 and 5) includes an extension shank 10, a sleeve 20 and a control bar 30.

The extension shank 10 includes a socket formed at an end and an insert 11 formed at an opposite second end. The second end of the extension shank 10 defines an axial cavity 13, at least one hole or slot 14 communicated with the axial cavity 13 and a hole 15 communicated with the axial cavity 13.

The control bar 30 includes a hole 31 defined therein, a deep recess 32 defined therein and a shallow recess 33 located next to the deep recess 32.

The sleeve 20 includes a tunnel 21 defined therein, an annular groove 22 defined in an external side thereof, at least a hole 23 defined therein and communicated with the annular groove 22 and a plurality of annular ribs 25 formed on the external side thereof for facilitating a user's movement of the sleeve 20.

In assembly, a spring 17 is put in the axial cavity 13 before the control bar 14 is inserted in the axial cavity 13. A fastener 16 is inserted in the at least one hole 23 defined in the sleeve 20, the at least hole or slot 14 defined in the extension shank 10 and the hole 31 defined in the control bar 30. Thus, the sleeve 20 and the control bar 30 are combined. A ring 24 is received in the annular groove 22, thus retaining the fastener 16 in position and therefore the sleeve 20 and the control bar 30 combined. The diameter or length of the at least one hole or slot 14 is greater than the diameter of the fastener 16, thus allowing the sleeve 20 and the control bar 30 to move relative to the extension shank 10. A ball detent 12 is put in the hole 13. The wall of the hole 15 is processed so as to trap the ball detent 12 in the hole 15.

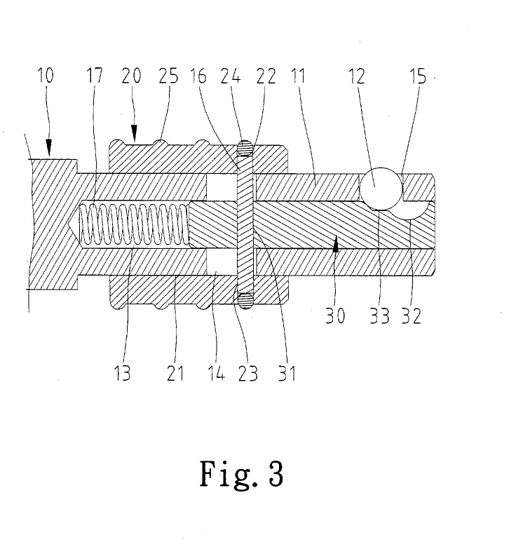

Referring to FIG. 3, the spring 17 is compressed between a closed end of the axial cavity 13 and an end of the control bar 14. The spring 17 pushes the control bar 14 to a first position where the ball detent 12 includes a lower portion received in the shallow recess 33 and an upper portion extending from the hole 15.

Referring to FIG. 4, the sleeve 20 and therefore the control bar 30 can be moved to a second position where the lower portion of the ball detent 12 is received in the deep recess 32 and the upper portion of the ball detent 12 is hidden in the hole 15. Thus, the tool bit defining an axial cavity 41 and a recess 42 defined in the wall of the axial cavity 41 can be mounted on the insert 11.

Referring to FIG. 5, when the sleeve 20 is released, the spring 17 pushes the control bar 14 back to the first position where the lower portion of the ball detent 12 is received in the shallow recess 33 and the upper portion of the ball detent 12 extends from the hole 15 into the recess 42, thus locking the tool bit 40.

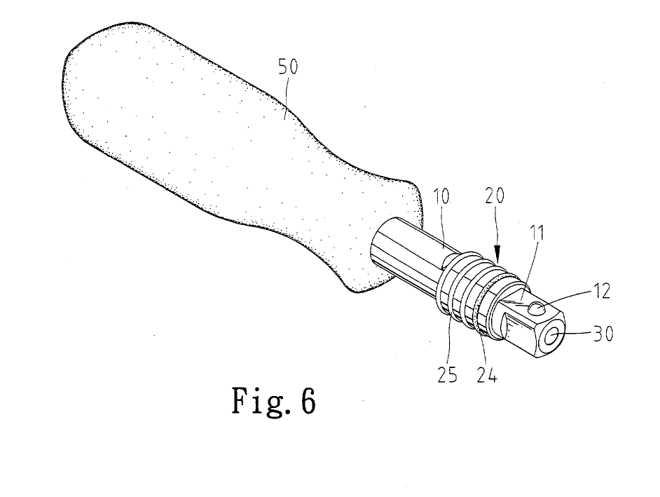

FIG. 6 shows a connector according to a second embodiment of the present invention. The second embodiment differs from the first embodiment in that the first end of the extension shank 10 is inserted in a handle 50.

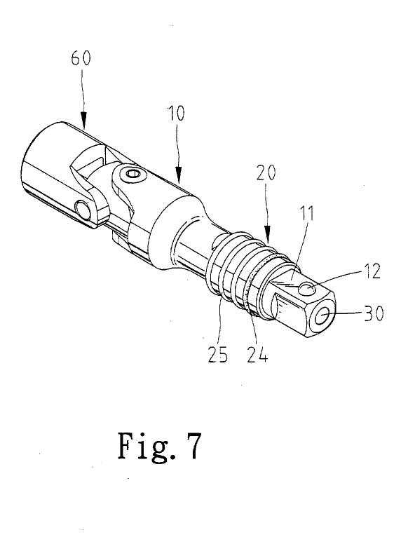

FIG. 7 is a perspective view of a connector according to a third embodiment of the present invention. The third embodiment differs from the first embodiment in that the first end of the extension shank 10 is integrated with a universal joint 60.

The present invention has been described via illustration of some embodiments. The applicant gives these embodiments only as examples, and those skilled in the art can derive variations from the embodiments after a study of this specification. Therefore, these embodiments shall not limit the scope of the present invention that is defined in the following claims.

What is claimed is:

1. A connector including:
an extension shank including a first end for engagement with a tool, a second end for engagement with a tool bit, an axial cavity defined in the second end and first and second holes communicated with the axial cavity;
a sleeve defining a tunnel and a hole communicated with the tunnel;
a control bar defining a hole, a deep recess and a shallow recess located near the deep recess;
a spring put in the axial cavity before the control bar is inserted in the axial cavity;
a fastener inserted in the hole defined in the sleeve, the first hole defined in the extension shank and the hole defined in the control bar for combining the sleeve with the control bar, the diameter of the first hole defined in the extension shank being greater than that of the fastener for allowing the sleeve and the control bar to move relative to the extension shank; and
a ball detent trapped in the second hole defined in the extension shank, wherein the spring pushes the control bar to a first position where the ball detent includes a first portion received in the shallow recess and a second portion extending from the second hole defined in the extension shank, and the sleeve and therefore the control bar can be moved to a second position where the first portion of the ball detent is received in the deep recess and the second portion of the ball detent is hidden in the second hole defined in the extension shank.

2. The connector according to claim 1 including a ring mounted on the sleeve, thus retaining the fastener in position and therefore the sleeve and the control bar combined.

3. The connector according to claim 2 wherein the sleeve defines an annular groove defined in an external side thereof for receiving the ring.

4. The connector according to claim 1 wherein the sleeve includes a plurality of annular ribs formed on an external side thereof.

5. The connector according to claim 1 wherein the extension shank includes a socket formed at the first end.

6. The connector according to claim 1 wherein the first end of the extension shank is inserted in a handle.

7. The connector according to claim 1 wherein the first end of the extension shank is integrated with a universal joint.

8. The connector according to claim 1 wherein the extension shank includes an insert formed at the second end.
